(19) United States
(12) Patent Application Publication
(10) Pub. No.: US 2007/0029453 A1
(43) Pub. Date: Feb. 8, 2007

(54) Fixing support structure for portable visual electronic products

(76) Inventor: Chen Kuo Hsiung, Laguna City (HK)

Correspondence Address: JACK SHORE;MUCH SHELIST FREED DENENBERG AMENT&RUBENSTEIN,PC, 191 N. WACKER DRIVE, SUITE 1800, CHICAGO, IL, 60606-1615, US

(21) Appl. No.: 11/249,781

(22) Filed: Oct. 13, 2005

(30) Foreign Application Priority Data
Aug. 2, 2005 (CN) 200520062216.7

(51) Int. Cl. F16M 11/00

(52) U.S. Cl. 248/176.1

(57) ABSTRACT

This new utility model is a fixing support structure for portable visual electronic products. It is composed of the fixing base and the guide slot at the back of the portable visual electronic product. The said fixing base can be movably slid into the guide slot and is connected to the portable visual electronic product. At the back of the said portable visual electronic product is a support, which is pivoted at one end to the back of the portable visual electronic product. This fixing support structure can be used to fix the portable visual electronic product stably and reliably to enable the user to enjoy programs without holding it with hands. The user no longer has to worry about the electronic product falling out of hands. This fixing support structure works in various ways. It applies to various automobiles, still or moving. Applicable to fixing all existing portable visual electronic products, this fixing support structure promises bright market prospect.

### CROSS REFERENCE TO RELATED APPLICATION

This application claims priority to Chinese Utility Application 200520062216.7 filed on Aug. 2, 2005.

### TECHNICAL FIELDS

This utility model is a fixing assembly, particularly a fixing support structure for portable visual electronic products.

### BACKGROUND TECHNOLOGIES

Portable visual electronic products are getting ever more diversified, such as PDA, pocket TV and palmtop audio-visual recorder-player (like MP4) and various portable DVD players. Light and compact these portable visual electronic products have become very popular and have found wide applications in various vehicles, such as automobiles, airplanes and ships, making our life more enjoyable either on trips or at work. However, such products have to be held in one's hands at present, which is very inconvenient for extended use or when our hands are otherwise engaged. In addition, the products may fall out of our hands and get damaged. It is therefore necessary to design a fixing support structure that can easily fit any portable visual electronic product. Other kinds of a fixing support for portable DVD players exist which is hinged to the back of a portable visual electronic product and can be furled against the back of the visual electronic product if not used, and unfolded for service. It forms a certain angle with the visual electronic product and serves to prop up the visual electronic product on a still level surface. However, this fixing support is unable to be used on other occasions, in moving vehicles such as automobiles.

### DESCRIPTION OF THE INVENTION

The purpose of this new utility model is to provide a simple, reliable and easy-to-use fixing support structure free from the present technical defects, for fixing portable visual electronic products in moving vehicles.

The purpose of this new utility model is achieved by the following technical scheme:

This fixing support structure for portable visual electronic products is composed of a fixing base and a guide slot at the back of the portable visual electronic product. The fixing base can be movably slid into the guide slot and is connected to the portable visual electronic product.

The guide slot is integrated with the portable visual electronic product; or it may be affixed, embedded or screwed to the portable visual electronic product.

The guide slot is a shaped like “II”, which is closed at three sides.

The fixing base includes a base body, which has a clamping flange, which is slid into the guide slot to connect the fixing base to the portable visual electronic product.

The fixing base is strapped to the headrest of the seat in the car, or fixed to the seat (such as the connecting rod between the seat and headrest of a car) via the connecting support, or absorbed to the glass of the car via a sucking disk, or fixed inside the car by other mechanical means.

At the back of the said portable visual electronic product is a support, which is pivoted at one end to the back of the portable visual electronic product.

The support, when furled against the back of the portable visual electronic product, is flush with the guide slot. The guide slot is located at the inner side of the support.

The support has a through hole at one end and the portable visual electronic product has a connection hole at the back. The pivot shaft passes through the through hole and the connection hole to connect the support to the portable visual electronic product.

At the end where the said support is pivoted to the portable visual electronic product is a flange, which presses against the back of the portable visual electronic product to limit the angle at which the support rotates and unfolds.

At the other end of the said support is a concave, and at the place of the back of the portable visual electronic product corresponding to the concave is a protruding buckle; when the support is furled against the back of the portable visual electronic product, the protruding buckle can be wedged into the concave to fix the support to the back of the portable visual electronic product; the support can be pulled up at the ends to detach the protruding buckle from the concave so as to make the support prop up the portable visual electronic product.

At the back of the portable visual electronic product, near the end of the support, is a concave, which allows the user to put in his fingers to turn up the support.

The said portable visual electronic product may be a portable DVD player, palmtop, pocket TV set, or palm-top audio-visual recorder-player (MP4).

This new utility model works like this: The fixing base of the fixing support structure of this portable visual electronic product is fixed to a fixture (such as the headrest) in a moving vehicle (like a car), and the portable visual electronic product is fixed to the moving vehicle by embedding the guide slot at the back of the said product along the flange on the fixing base, so that the user can watch programs stably, reliably and comfortably while traveling along the way. To use the portable visual electronic product on a still level surface, the user needs only to unfold the attached support and make the flange at its end press against the back of the portable visual electronic product to limit the angle at which the support rotates and unfolds.

This new utility model is superior to the existing technologies in the following respects: (1) safe and reliable: this fixing support structure can be used to fix the portable visual electronic product stably and reliably to enable the user to enjoy programs without holding it with their hands. The user no longer has to worry about the electronic product falling out of their hands. Therefore, this technology provides convenience and safety at the same time; (2) diversified functions and wide serviceability: This fixing support structure works in various ways. It serves to flexibly adjust the ways the user uses the electronic product. It applies to various automobiles, still or moving. Applicable to fixing all existing portable visual electronic products, this fixing support structure promises a bright market prospect.

### ATTACHED FIGURES

FIG. 1 is the diagram showing the fixing support structure of this new utility model.

FIG. 2 is the diagram showing another status of the fixing support structure shown in FIG. 1.

FIG. 3 is the diagram showing the structure of the support of the fixing support structure shown in FIG. 1.

FIG. 4 is the diagram showing the end connections of the support shown in FIG. 3.

FIG. 5 is the diagram showing this new utility model in use.

FIG. 6 is the diagram showing this new utility model in another use.

FIG. 7 is the diagram showing this new utility model in another use.

### IMPLEMENTATION DETAILS

This new utility model will be exemplified and illustrated in more detail below.

### EXAMPLE

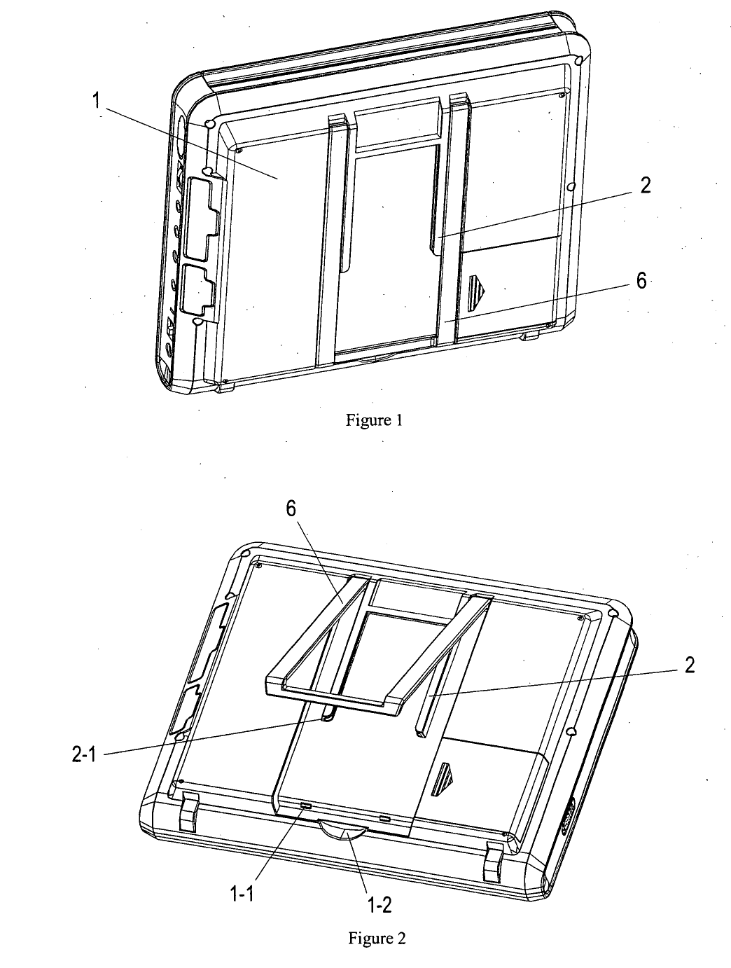

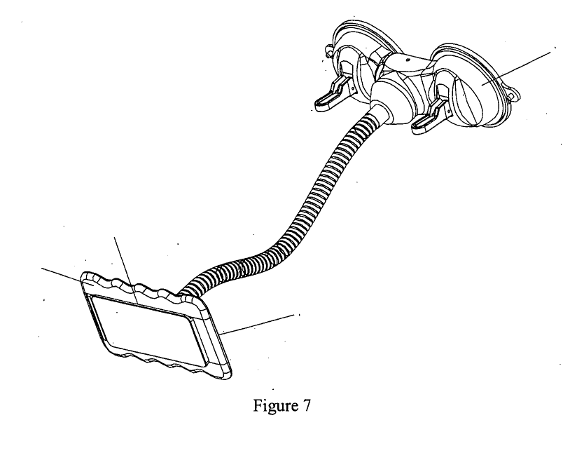

FIGS. 1-7 show the detailed structure of this new utility model. It may be seen from FIG. 1 that, at the back of the portable DVD player 1 of this new utility model is an integral guide slot 2, which is shaped like “II” closed at three sides, and at the open end of guide slot 2 is arc-shaped bevel edge 2-1 (See FIG. 2). The fixing base 3 as shown in FIGS. 6 and 7 can be connected to guide slot 2. The fixing base 3 comprises base body 3-1, has a clamping flange 3-2. The said clamping flange 3-2 is embedded along the said guide slot 2 to connect the fixing base 3 to the portable DVD player 1.

The fixing base 3 can be fixed to the seat (such as the connecting rod between the seat and headrest of a car) via the connecting support 4 (see FIG. 6), or absorbed to the glass of the car via a sucking disk 5 (see FIG. 7), so as to fix the portable DVD player 1 inside the car.

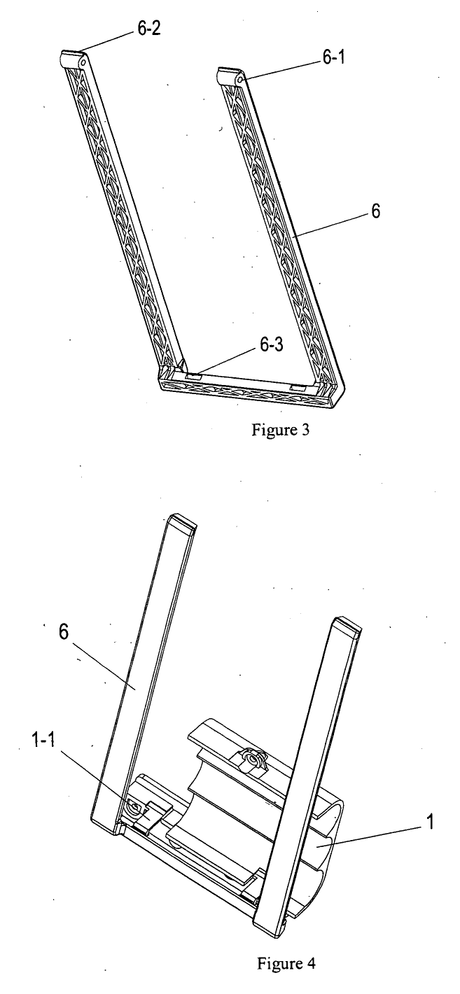

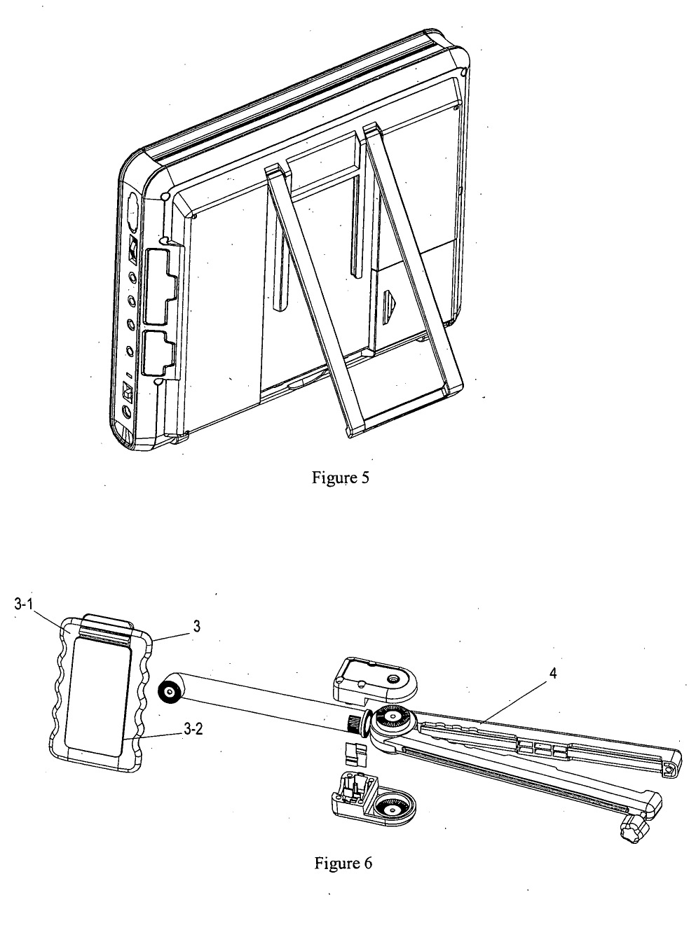

At the back of the portable DVD player 1 is the support 6 (see FIG. 2), which, when furled against the back of the portable DVD player 1, is flush with the guide slot 2 (see FIG. 1. The guide slot 2 is located at the inner side of the support 6. The support 6 has a through hole 6-1 (see FIG. 3) at one end and the portable DVD player 1 has a connection hole at the back. A pivot shaft passes through the through hole 6-1 and the connection hole to pivot the support 6 to the portable DVD player 1. At one end of the support 6 is a flange 6-2 (see FIG. 3), which presses against the back of the portable DVD player 1 to limit the angle at which the support 6 rotates and unfolds. At the other end of the support 6 is a concave 6-3, and at a place at the back of the portable DVD player 1 corresponding to the concave 6-3 is a protruding buckle 1-1, as shown in FIG. 4. When the support 6 is furled against the back of the portable DVD player 1, the protruding buckle 1-1 can be wedged into the concave 6-3 to fix the support 6 to the back of the portable DVD player 1. The support 6 can be pulled up at the ends to detach the protruding buckle 1-1 from the concave 6-3 so as to make the support prop up the portable DVD player (see FIG. 5). At the back of the portable DVD player 1, near the end of the support 6, is a concave 1-2 (see FIG. 2), which allows the user to put in his fingers to turn up the support 6.

This new utility model works like this: The fixing base 3 of the fixing support structure is fixed to a fixture (such as the headrest or glass) in a moving vehicle (like a car). The portable DVD player 1 is fixed to the moving vehicle by embedding the fixing base 3 in the guide slot 2 at the back of the said product along the flange 3-2, so that the user can watch programs stably, reliably and comfortably while traveling along the way. To use the portable DVD player 1 on a still level surface, the user needs only to unfold the attached support 6 and make the flange 6-2 at its end press against the back of the portable DVD player 1 to limit the angle at which the support rotates and unfolds.

Above is a good example of implementation of this new utility model, but this new utility model is not limited to the above implementation example. Other modifications, decorations, substitutions, combinations, and simplifications not against the essential nature and principle of this new utility model are all equivalent replacement modes within the protection range for this new utility model.

1. The fixing support structure of a portable visual electronic product with the following features: It is composed of the fixing base and the guide slot at the back of the portable visual electronic product. The said fixing base can be movably slid into the guide slot and is connected to the portable visual electronic product.

2. The fixing support structure of a portable visual electronic product as described in claim 1 with the following features: The said guide slot is integrated with the portable visual electronic product.

3. The fixing support structure of a portable visual electronic product as described in claim 1 with the following features: The said fixing base includes a base body, which has a clamping flange, which in turn is embedded along the said guide slot to connect the fixing base to the portable visual electronic product.

4. The fixing support structure of a portable visual electronic product as described in claim 1 or 3 with the following features: The said fixing base is strapped to the headrest of the seat in the car, or fixed to the seat via the connecting support, or adsorbed to the glass of the car via a sucking disk.

5. The fixing support structure of a portable visual electronic product as described in claim 1 with the following features: At the back of the said portable visual electronic product is a support, which is pivoted at one end to the back of the portable visual electronic product.

6. The fixing support structure of a portable visual electronic product as described in claim 5 with the following features: The said support, when furled against the back of the portable visual electronic product, is flush with the guide slot. The said guide is located at the inner side of the support.

7. The fixing support structure of a portable visual electronic product as described in claim 5 with the following features: The said support has a through hole at one end and the portable visual electronic product has a connection hole at the back. The pivot shaft passes through the through hole and the connection hole to connect the support to the portable visual electronic product.

8. The fixing support structure of a portable visual electronic product as described in claim 7 with the following features: At the end where the said support is pivoted to the portable visual electronic product is a flange, which presses against the back of the portable visual electronic product to limit the angle at which the support rotates and unfolds.

9. The fixing support structure of a portable visual electronic product as described in claim 7 with the following features: At the other end of the said support is a concave, and at the place of the back of the portable visual electronic product corresponding to the concave is a protruding buckle; the said protruding buckle is wedged into the concave.

10. The fixing support structure of a portable visual electronic product as described in claim 9 with the following features: At the back of the portable visual electronic product, near the end of the support, is a concave.
